(19) United States
(12) Patent Application Publication
(10) Pub. No.: US 2014/0150101 A1
(43) Pub. Date: May 29, 2014

(54) METHOD FOR RECOGNIZING MALICIOUS FILE

(71) Applicant: Xecure Lab Co., Ltd., Taipei City (TW)

(72) Inventors: Ming-Chang Chiu, Taipei City (TW); Ming-Wei Wu, Taipei City (TW); Ching-Chung Wang, Taipei City (TW); Che-Kuo Hsu, Taipei City (TW); Pei-Kan Tsung, Taipei City (TW)

(73) Assignee: Xecure Lab Co., Ltd., Taipei City (TW)

(21) Appl. No.: 14/167,151

(22) Filed: Jan. 29, 2014

Related U.S. Application Data
(63) Continuation-in-part of application No. 13/612,802, filed on Sep. 12, 2012.

(51) Int. Cl. H04L 29/06

(52) U.S. Cl. CPC H04L 63/1425
USPC 726/22

(57) ABSTRACT

A method for recognizing malicious file has steps: receiving a static file through a network or an input/out interface to be stored in the memory; defining suspicious positions where components of a malware are possibly encrypted in the static file; decrypting the suspicious positions to identify a PE header and a shellcode; extracting the PE header and the shellcode terms in segments; and determining whether the PE header and the shellcode terms can be assembled into an executable binary which indicates a recognition of the malicious file.

### RELATED MATTERS

This application claims the benefit of the earlier filling date of pending application Ser. No. 13/612,802, filed on Sep. 12, 2012, entitled “method for extracting digital fingerprints of A malicious document file”.

### BACKGROUND OF THE INVENTION

1. Field of the Invention

This invention relates to a method for recognizing a malicious file particularly through a manner, which includes extracting codes and reassembling the codes, and finally determining whether the assembled code is executable in order to recognize a file with malicious program hiding in.

2. Description of Related Art

In regards to malicious file, malwares may attack computer system through different ways. For example, a malware may be encrypted in several segments distributed within the code of a normal file, such as doc file, xls file, ppt file, pdf file and etc. For users, this kind of malicious file is usually considered as a normal file that could be a text document, figure or video file received through internet or any connected portable device. Once the normal file is executed, the encrypted malware could be executed simultaneously and accessing the operating system.

A general approach for recognizing the malicious file is to extract multi-segments from the file as a fingerprint or signature of the file. With means of heuristics, the signature of file is then compared with a blacklist established in accordance with publicly known malware codes, so as to determine whether the file has malicious behavior.

Most approaches prevent computer malwares in a passive way that arranges several surveillance gates in the computer system to catch the malware intending to access somewhere in the system. Namely, if the malware invades other location where has no surveillance gate, the system is then infected. If further putting up more surveillance gates in the computer system, the computing burden relatively increases and as well slows down the computation.

Foregoing approach may effectively recognize the known malwares encrypted in normal files. However, the approach is not effective for the unknown or new malwares, as there is no record of feature for such new malwares in the blacklist. Therefore, there is a need of an ability for recognizing and predicting new malwares, even lacking of enough features about the malwares.

### SUMMARY OF THE INVENTION

The objective of the present invention is to provide a method for recognizing malicious file, through only one virtual environment, prior to executing a received file, avoiding the malicious software or malware encrypted in the file to access the operating system.

In order to achieve the foregoing objective, the method of the present invention includes the following steps: receiving a static file through a network or an input/out interface to be stored in the memory; defining suspicious positions where components of a malware are possibly encrypted in the static file; decrypting the suspicious positions to identify a PE header and a shellcode; extracting the PE header and the shellcode terms in segments; and determining whether the PE header and the shellcode terms can be assembled into an executable binary which indicates a recognition of the malicious file.

### BRIEF DESCRIPTION OF THE DRAWINGS

The invention, as well as its many advantages, may be further understood by the following detailed description and drawings in which:

FIG. 1 is a block diagram of a system for malicious file recognition in accordance with the present invention.

FIG. 2 is a flowchart showing the process of malicious file recognition in accordance with the present invention.

### DETAILED DESCRIPTION OF THE INVENTION

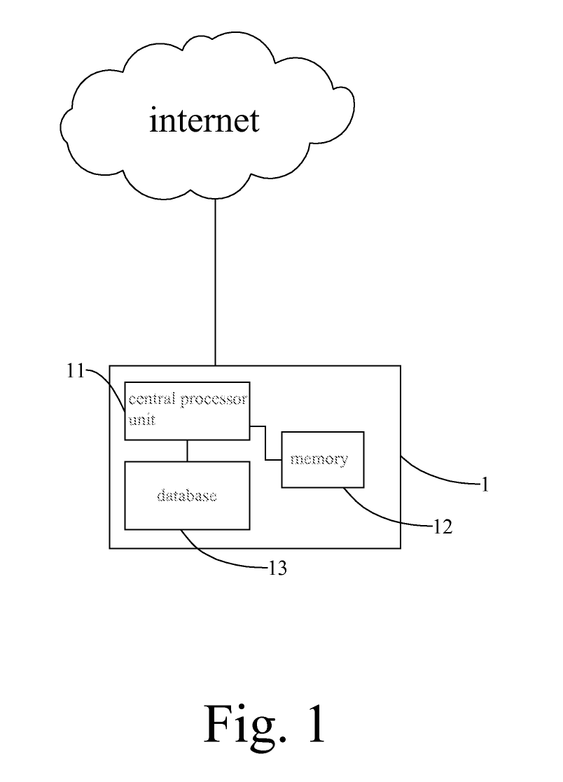

With reference to FIG. 1, the system 1 for recognizing malicious file includes a central processor unit 11 (CPU) for computer program procession and execution, a memory 12 for program storage and a database 13 established according to information about features of known malwares and unknown malwares. The system could be an user's computer or a network sever, which is capable of receiving documents or files through network transmission, or through an input/output interface coupled to an external device, such as USB flash, disk reader. The memory 12 stores computer programs and data that received from the network or the input/output interface.

Said malicious file in the present invention relates to a static file or data that encrypts a malware therein, which is hardly recognized via anti-virus software because the malware is usually disassemble in parts including a program executable header (PE header) and at least one segment of shellcode which are separately encrypted in the static file. Thus, for users, the static file looks normal in appearance. For the anti-virus software, the static file may not be recognized prior to the execution. That means, when users receive the malicious file from email transmission or any input device without vigilance, the hidden malware is then readily initiated until the users open the file.

The database 13 includes a fingerprint (also called signature) data which is established according to features of the malwares by machine learning method. The machine learning method is capable of analyzing the publicly known malwares and converting the regulation of that into fingerprint features of malwares. In other words, the fingerprint of a malware is an indicator referring to where the PE header and the shellcode possibly distribute in the static file. Since the machine learning method is common in the art, the description thereof is omitted.

Additionally, the database 13 may further include a shellcode data which is established according to publicly known references for shellcode, such as common vulnerabilities and exposures (CVE) numbers. With this shellcode data, the known malwares are easily identified through a comparison manner.

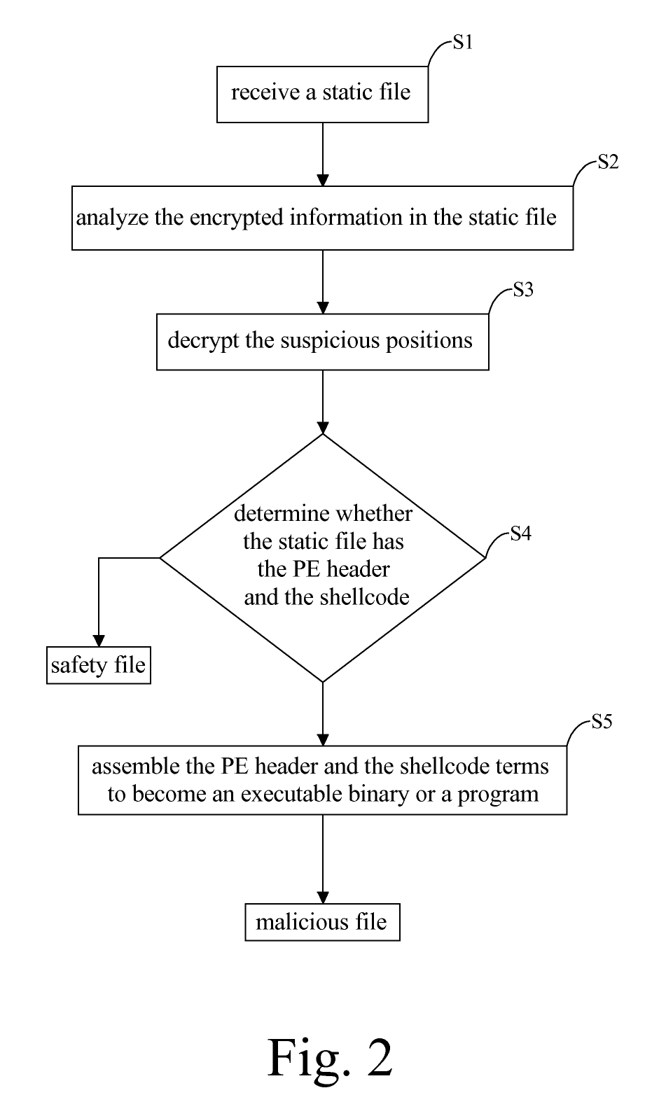

With reference to FIG. 2, the process of malicious document recognition in accordance with the present invention has following steps, S1-S5 which are proceeded by the foregoing system.

Step S1: receive a static file via neteork or the input/output interface, and store the static file in the memory.

Step S2: analyze the encrypted information in the static file. When a file is newly stored in the memory, the CPU then automatically starts analyzing the file without any execution. As aforementioned, a malware could be divided into several components respectively encrypted in the file, therefore, the preliminary is to find out suspicious positions where the components of the malware may be encrypted. The suspicious positions are determined by an entropy approach which is a method of measuring the regularity in the information (a serious of numbers, characters, bytes or a combination thereof) of the file. An entropy H(x) of the information in the static file is computed using following formula:

$$H ( x ) = - {\sum }_{i = 1}^{n} p ( i ) {log}_{2} p ( i ) ,$$

where p(i) is a probability of the i^{th} unit of the information in the static file, which depends on the quantity “n” of a selected string. For instance, 256 characters is preferred, and thus the computed entropy is bounded within a range of 0-8.

With the computed value of the entropy, the regularity of the information in the static file is then obviously presented. The suspicious positions are located where the entropies in the information are the lowest or the highest, which indicates a high tendency that the PE header and the shellcode of the malware are encrypted here.

Step S3: decrypt the suspicious positions. In step S2, it is no evidence to prove the suspicious positions having the PE header and shellcode, because most of the malwares are encrypted to avoid detection. Therefore, step S3 is to decrypt the suspicious positions that may encrypted the malware components using brute-force attack which is a method of calculating password in a way of testing all possible combinations.

Step S4: determine whether the static file has the PE header and the shellcode. After decryption, the locked informations scattering in the file are then exposed, but locations of the PE header and the shellcode are still unable to be confirmed. In order to find out the malware components, the preliminary is to compare the decrypted section with the fingerprint data that stored in the database. Consequently, the PE header and the shellcode are able to be identified if the codes are identically or similarly matching up with the features recorded in the fingerprint data.

Secondary is to carry out a multi-segment extraction to extract the identified PE header and shellcode in segments, wherein each of segment is a multiple of binary (32 bytes, 64 bytes, 256 bytes or etc.) depending on the CPU ability. Consequently, the extraction includes terms of the PE header and the shellcode that are suspiciously regarded as the malware components.

Alternatively, the static file is then marked as a safety file (operating system accessible) in which none of the PE header and shellcode terms are included; otherwise the static file is then marked as a suspicious file that includes the PE header and shellcode both of which are not belonging to the static file. However, defining the suspicious file is not equally recognizing the malicious file due to the unknown capability of the assembly of the PE header and shellcode terms.

Step S5: assemble the PE header and the shellcode terms that extracted from the suspicious file to become an executable binary or a program. An executable combination of the terms can be found by checking all the combining possibilities and checking whether each of the possible combinations is executable in one predetermined virtual environment. With this result, a suspicious file having the PE header and shecode terms that are combinable and executable is then considered as a malicious file, namely the malicious file is recognized.

To speed up the forgoing checking manner, the terms are able to be assembled in reference to the fingerprint data. The fingerprint data provides features (such as program code) that the malware could have, and thus helping quickly looking for the executable combination.

Moreover, the executable combination can be determined as a new malware or a public known malware through comparison with CVE data.

However, in some specific situations, the terms cannot be well assembled using such permutations and combinations manner, especially a newly created malware, in other words, other assembling manners could be introduced in step S5 to convert these terms into an executable.

By the method of the invention, whatever the malware hidden in the malicious file is known or unknown, both are able to be detected and recognized through the multi-segment extraction extracting the PE header and the shellcode which are highly related to the malware components, and the capability of the malware is also confirmed by the assembled executable binary. Furthermore, a newly recognized malware can be recorded and stored in the database, helping to create more malware samples for future use.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for recognizing malicious file, carried out by a computer system including a memory and connecting a database storing a numerous of malware features, comprising steps of:
receiving a static file through a network or an input/out interface to be stored in the memory;
defining suspicious positions where components of a malware are possibly encrypted in the static file;
decrypting the suspicious positions to identify a PE header and a shellcode;
extracting the PE header and the shellcode terms in segments; and
determining whether the PE header and the shellcode terms can be assembled into an executable binary which indicates a recognition of the malicious file.

2. The method as claimed in claim 1, wherein the malware features stored in the database includes fingerprint data.

3. The method as claimed in claim 1, wherein the suspicious positions are defined in accordance with entropy of characters or codes of the static file.

4. The method as claimed in claim 1, wherein each of the extracting segments is a multiple of binary.

5. The method as claimed in claim 1, wherein the executable binary, if it is unknown before, is converted into a new fingerprint data to be stored in the database.
